(19) United States
(12) Patent Application Publication
(10) Pub. No.: US 2011/0248449 A1
(43) Pub. Date: Oct. 13, 2011

(54) COMBINED SEALING DEVICE FOR A ROTARY SHAFT

(75) Inventors: Decai Li, Beijing (CN); Xiaolong Yang, Beijing (CN)

(73) Assignee: Beijing Jiaotong University

(21) Appl. No.: 13/040,351

(22) Filed: Mar. 4, 2011

(30) Foreign Application Priority Data
Apr. 12, 2010 (CN) 201010146832.6

(51) Int. Cl. F16J 15/43

(52) U.S. Cl. 277/302

(57) ABSTRACT

A combined sealing device for a rotary shaft, in which the combined sealing device comprises the ring (5), the left bearing (6), the left septum magnetic ring (7), a magnetic fluid sealing assembly, the right septum magnetic ring (11), and the right bearing (12) which are arranged inside a housing (18) in series, after the magnetic fluid is injected into the pole teeth of pole pieces in the magnetic fluid sealing assembly, the shaft housing is loaded into the inner hole of the above-mentioned parts, then the second end cover (15) is fixed on a housing by screw nails (16) to press the outer ring of the right bearing tightly, after that, the first end cover (14) is fixed on the shaft housing (1) by screw nails (13) to press the inner ring of right bearing tightly, so that a magnetic fluid seal is device is achieved, the left end external surface of the shaft housing is the conical surface, and the left end inner hole of the housing is the taper hole which has the same taper as the left end of shaft housing and in which spiral groove is processed, the left end external conical surface of the shaft housing coordinates with the left end spiral groove of the housing provided in the taper hole, so that a conical spiral seal is achieved. This device has the advantages such as a long service life, a reliable seal, and no pollution.

### FIELD OF THE PRESENT INVENTION

This invention relates to a combined sealing device for a rotary shaft, which belongs to the field of mechanical seals.

### BACKGROUND OF THE PRESENT INVENTION

At present, the research of gas seal in a rotating machinery is relatively too much and mature, but the research of a liquid seal, especially under harsh conditions such as low temperature, no pollution and no leakage, is relatively few. In recent years, the liquid seal in the rotating machinery mainly applies a packing seal. Although the packing seal has advantages such as simple structure and easy operation, the larger friction and wear between the packing and the rotating parts, more power consumption, and unreliable seal have been noted unfortunately. Under present circumstances, the problem of liquid leakage cannot be solved completely by applying some sealing method alone. Therefore, it is a big challenge to improve the liquid sealing property in the rotating machinery.

### SUMMARY OF THE PRESENT INVENTION

The object of the present invention is to provide a combined sealing device for a rotating machinery so as to seal liquid under harsh conditions such as low temperature, no pollution and no leakage.

Technical solution of the invention is as follows.

There is provided a combined sealing device for a rotary shaft, comprising the ring, the left bearing, the left septum magnetic ring, the magnetic fluid sealing assembly, the right septum magnetic ring and the right bearing, which are arranged inside a housing in series. After the magnetic fluid is injected into the pole teeth of pole pieces in the magnetic fluid sealing assembly, the shaft housing is loaded into the inner hole of the above-mentioned parts. Then the second end cover is fixed on the housing by screw nails to press the outer ring of the right bearing tightly. After that, the first end cover is fixed on the shaft housing by screw nails to press the inner ring of right bearing tightly. Magnetic fluid seal is achieved.

The left end external surface of the shaft housing is the conical surface, and the left end inner hole of the housing is the taper hole which has the same taper as the left end of shaft housing and in which spiral groove is processed. The left end external conical surface of the shaft housing is in engagement with the left end spiral groove of the housing provided in the taper hole. The conical spiral seal is achieved.

The thread form of the spiral groove as mentioned above is selected as rectangular thread, where the thread groove width is 1.5 mm, the thread groove depth is 1 mm, and the cone angle of taper hole is 5°. The gap of the spiral groove processed between the left end external conical surface of the shaft housing and the left end taper hole of a housing is 0.2 mm.

With the beneficial effects of the invention, the invention applies the combined sealing style of a spiral seal and a magnetic fluid seal which are both non-contact seals and non-friction parts, so it has a long service life, a high seal reliability, a zero leakage, and no pollution, and a low installation precision is required by the spiral seal, When the rotary shaft is in motion or at rest, the magnetic fluid plays a role of seal and makes the spiral seal without any additional stop seal. The combined sealing device is a compact construction device which is easy to install and easy to operate.

### BRIEF DESCRIPTION OF THE ACCOMPANYING DRAWING

FIG. 1 is a schematic view of a combined sealing device for a rotary shaft.

In the FIGURE, there are shown a shaft housing 1, a spiral groove 2, a rubber sealing ring 3, a through-hole 4, a circular ring 5, the left bearing 6, the left septum magnetic ring 7, the left pole piece 8, a permanent magnet 9, the right pole piece 10, the right septum magnetic ring 11, the right bearing 12, screw nails 13, the first end cover 14, the second end cover 15, screw nails 16, the right rubber sealing ring 17, a housing 18, the left rubber sealing ring 19, and the magnetic fluid 20.

### PREFERRED EMBODIMENTS TO CARRY OUT THE PRESENT INVENTION

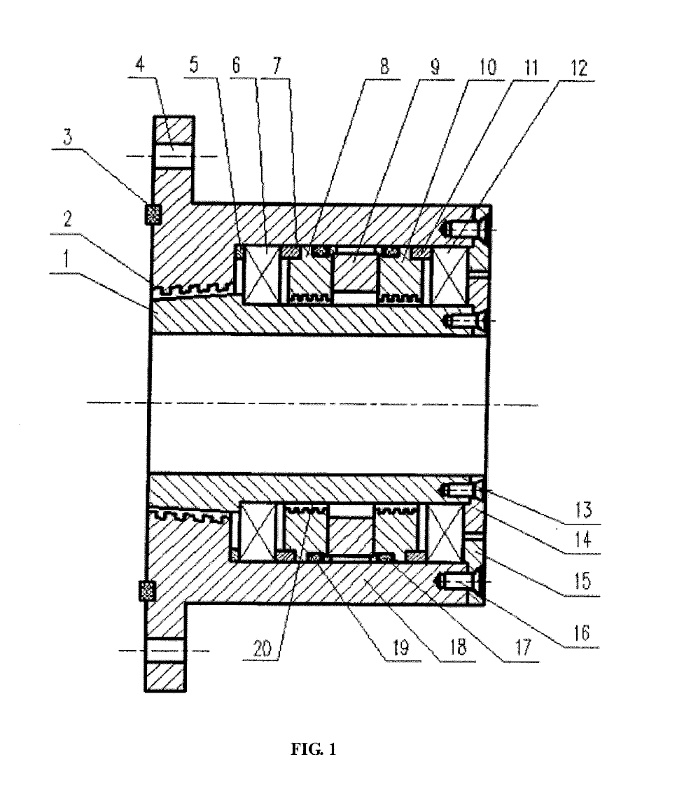

A further explanation of this invention is made with the accompanying drawing, as shown in FIG. 1.

It is provided a combined sealing device for a rotary shaft, in which the seal consists of a conical spiral groove seal and a magnetic fluid seal.

This combined sealing device includes the shaft housing 1, the rubber sealing ring 3, the circular ring 5, the left bearing 6, the left septum magnetic ring 7, the magnetic fluid sealing assembly, the right septum magnetic ring 11, the right bearing 12, the screw nails 13, the first end cover 14, the second end cover 15, the screw nails 16, the right rubber sealing ring 17, a housing 18, and the left rubber sealing ring 19.

The magnetic fluid sealing assembly consists of the left pole piece 8, the permanent magnet 9, and the right pole piece 10, in which the left pole piece 8, the permanent magnet 9, and the right pole piece 10 are bonded together in series. The rubber sealing ring 17 is installed inside an annular groove provided on an circumferential surface of the right pole piece 10. The left rubber sealing ring 19 is installed inside an annular groove provided on an circumferential surface of the left pole piece 8. When the combined sealing device for a rotary shaft is assembled, the magnetic fluid 20 is injected into the pole teeth of the left pole piece 8 and the right pole piece 10.

The combined sealing device is with a structure as follows.

In the combined sealing device for a rotary shaft, the circular ring 5, the left bearing 6, the left septum magnetic ring 7, the magnetic fluid seal assembly, the right septum magnetic ring 11, and the right bearing 12 are arranged inside a housing 18 in series. After the magnetic fluid is injected into the pole teeth of pole pieces in magnetic fluid seal assembly, the shaft housing 1 is loaded to the inner pole of the above-mentioned parts. Then the second end cover 15 is fixed on the housing 18 by the screw nails 16 to press the outer ring of the right bearing 12 tightly. After that, the first end cover 14 is fixed on the shaft housing 1 by the screw nails 13 to press the inner ring of right bearing 12 tightly. In this way, a magnetic fluid seal is achieved.

The external surface on the left end of the shaft housing 1 is a conical surface, and the left end inner hole of the housing 18 in which spiral groove is provided is the taper hole which has the same taper as the left end of the shaft housing 1. The left end external conical surface of the shaft housing 1 coordinates with the left end spiral groove of the housing 18 provided in the taper hole. The conical spiral seal is achieved.

The thread form of spiral groove as mentioned above is selected as rectangular thread, where the thread width is 1.5 mm, the thread groove depth is 1 mm, and the cone angle of taper hole is 5°. The clearance of the spiral groove formed between the left end external conical surface of the shaft housing 1 and the left end taper hole of the housing 18 is 0.2 mm.

The magnetic fluid 20 is selected to be an iron-cobalt magnetic fluid. The rubber sealing ring 3 is put inside the ring groove provided on the left end face of the housing 18. The through-hole 4 is used for connecting the devices which require sealing.

When the shaft rotates at high speed, the medium in the device will be sent into the spiral groove 2 along the gap under a certain pressure. The medium which is full in the spiral groove 2 will generate pumping pressure head while the conic portion on the surface of the shaft housing 1 will also make the medium produce a pressure head. When both pressure heads are equal to the medium pressure in the seal chamber, the seal effect can be obtained to prevent leakage of the medium in the device. When the shaft stops running, the magnetic fluid plays a major role of seal. The permanent magnet 9, the housing 18, the magnetic fluid 20, and the two pole pieces form a magnetic field lines loop. The bound magnetic field which the permanent magnet 9 generates in the sealing gap acts on the magnetic fluid 20 and makes it adsorbed on the surface of the shaft housing 1 and in the gap formed by the two pole pieces, thus it is equivalent to form more liquid “O” seal ring, so that a dynamic sealing function is achieved.

1. A combined sealing device for a rotary shaft, in which the combined sealing device comprises a ring (5), the left bearing (6), the left septum magnetic ring (7), a magnetic fluid sealing assembly, the right septum magnetic ring (11), and the right bearing (12) which are arranged inside a housing (18) in series, after the magnetic fluid is injected into the pole teeth of pole pieces provided in the magnetic fluid sealing assembly, a shaft housing (1) is loaded into the inner hole of the above-mentioned parts, then the second end cover (15) is fixed on the housing (18) by screw nails (16) to press the outer ring of the right bearing (12) tightly, after that, the first end cover (14) is fixed on the shaft housing (1) by screw nails (13) to press the inner ring of right bearing (12) tightly, so as to form a ferrofluid seal, characterized in that
the external surface on the left end of the shaft housing (1) is the conical surface, and the left end inner hole of the housing (18) in which a spiral groove is provided is formed a taper hole which has the same taper as the left end of shaft housing (1), and the left end external conical surface of the shaft housing (1) coordinates with the left end spiral groove of the housing (18) provided in the taper hole, so that a conical spiral seal is achieved.

2. A combined sealing device for a rotary shaft according to claim 1, characterized in that the thread of the spiral groove is of a rectangular thread, where the thread groove width is 1.5 mm, the thread groove depth is 1 mm; the cone angle of taper hole is 5°; and the clearance of the spiral groove provided between the left end external conical surface of the shaft housing (1) and the left end taper hole of the housing (18) is 0.2 mm.
